(19) United States
(12) Patent Application Publication
(10) Pub. No.: US 2024/0351052 A1
(43) Pub. Date: Oct. 24, 2024

(54) AERIAL NOZZLE CAP SYSTEM

(71) Applicant: Application Insight, LLC, Lansing, MI (US)

(72) Inventors: Mark Allen Ledebuhr, Lansing, MI (US); Nicholas Charles Tipper, Saint Johns, MI (US); Sarah Marie Ziehm, Lansing, MI (US)

(21) Appl. No.: 18/302,989

(22) Filed: Apr. 19, 2023

(51) Int. Cl. B05B 1/34; B05B 1/28; B05B 15/55

(52) U.S. Cl. CPC B05B 1/34; B05B 1/28; B05B 15/55; A01C 23/005

(57) ABSTRACT

An aerial nozzle cap, configured to connect a spray tip to a nozzle body of an aerial spray applicator fluid distribution system, the aerial nozzle cap comprising: an aerodynamic hood extending downstream and away from the spray tip, the aerodynamic hood configured to shield the spray tip and spray jet fluid emitted from the fluid distribution system from airflow passing over the nozzle cap during a spray application; wherein the hood is configured to shape the airflow conditions around the spray tip and nozzle cap to form a zone of lower velocity and lower energy air during the spray application to prevent undesired droplet formation. The nozzle cap may include a substantially cylindrical continuous “bullet” geometry having a bullet cap connected to a bullet body.

### TECHNICAL FIELD

The present disclosure relates generally to an aerial spray applicator, particularly to aerial spray applicator systems and assemblies used for agriculture applications.

### BACKGROUND

The statements in this section merely provide background information related to the present disclosure and may not constitute prior art.

Aerial spray nozzles are used in agricultural applications during aerial application of fertilizer, pesticides, and the like. Aerial agrochemical application or “crop-dusting” is a common method used in large scale agricultural operations as an efficient and effective way of applying desired liquid solutions to a large area of crops. However, crop-dusting is heavily dependent on external factors such as wind speed, aircraft speed, and viscosity of the liquid agrochemical.

These factors can affect the dispersion and drift of the agrochemical, which should be applied uniformly and within a relatively narrow application range. Unintended drift and off-swath dispersion wastes valuable resources and poses a safety and liability concern for affected and adjoining properties. The Federal Government has promulgated regulations concerning drift limits allowed onto adjacent (non-target) properties. Due to these regulations, applications may only occur during certain ideal environmental conditions that minimize or eliminate drift.

Current technology involves specialized aircrafts flying low over a target area and applying an agrochemical via a system of nozzles that spray in a direction away from the aircraft. These systems may involve a plurality of nozzles attached to a liquid distribution spray boom. The spray boom is mounted below the wing to reduce exposure to turbulence generated from the wing during flight. Additionally, a J-tube may be implemented, which places the nozzle below the spray boom, thereby reducing the nozzle's exposure to turbulence generated by both the wing and the spray boom. Turbulent air currents around the nozzle orifice can cause rapid atomization of the spray jet fluid being expelled, which results in the formation of fine droplets. Fine droplets increase the risk of drift, and therefore increase inefficiencies and safety concerns.

Attempts to solve these problems have been made, such as Grocett et al. (U.S. Pat. No. 5,042,723), in which an apparatus is disclosed for electrostatic spraying from fixed wing aircraft. The apparatus includes a linear electrostatic spraying nozzle and electrodes placed near the nozzle's spraying edge to intensify the electric field strength at the spraying edge sufficiently to produce ligaments of the liquid to be sprayed from the spraying edge. This can help reduce the airstream, due to the aircraft's movement, from destroying the ligaments. The spray head and the electrodes are positioned so that part of the airstream flows between them. The spray head and the electrodes are shaped and positioned so that when directed to spray in substantially the same direction as the airstream, a turbulence free wake may be left in the region of the ligaments. Further, this method requires an additional apparatus and a power source.

A need remains for a solution directed at the interaction of spray jet fluid with the surrounding air flow. What is needed is an improved system that overcomes the issues resulting from the intersection of high-speed air and the fluid jet immediately in the adjacent downstream to reduce and/or eliminate the high energy turbulence that creates fine droplets in the sprayed liquid jet during application.

### SUMMARY

The present disclosure provides for an aerial nozzle cap, configured to connect a spray tip to a nozzle body of an aerial spray applicator fluid distribution system, the aerial nozzle cap comprising: an aerodynamic hood extending downstream and away from the spray tip, the aerodynamic hood configured to shield the spray tip and spray jet fluid emitted from the fluid distribution system from airflow passing over the nozzle cap during a spray application; wherein the hood is configured to shape the airflow conditions around the spray tip and nozzle cap to form a zone of lower velocity and lower energy air during the spray application to prevent undesired droplet formation.

In an example, the nozzle cap includes a coupling extending from a base of the nozzle cap hood configured to connect to the nozzle body and allow fluid to be dispersed within the zone of lower velocity air and lower energy air. In another example, the spray jet fluid can be an agrochemical fluid configured for an aerial agrochemical application over a desired target area. The nozzle cap can be sized and shaped to correspond to different spray tip sizes and airflow velocities of an aerial spray application.

In an example, the nozzle cap defines an outer rim diameter between 0.5 and 2.5 inches. In a further example, the nozzle cap has a ratio of length to outer rim diameter between about 0.75 and 3.0. The ratio of length to outer rim diameter can correspond to aerial application velocities from about 90 mph to about 160 mph.

In yet another example, the aerodynamic hood extends from the coupling configured to removably and securely connect the nozzle cap to the nozzle body. The aerodynamic hood can define a concave interior geometry and the spray tip protrudes within the concave body. In an example, the spray tip is formed integral with the nozzle cap and the nozzle body. The nozzle cap can define at least one orifice for dispersing fluid. In a still further example, the nozzle cap is configured to reduce undesired fine droplet formation of droplets of about 100 μm and smaller during application to less than about 10%.

The present disclosure further provides for an aerial nozzle assembly comprising: (a) a nozzle body extending in a downstream direction defining an opening at an upstream end for securely connecting to a fluid dispensing system and having at least one internal fluid channel extending to a downstream end; (b) a coupling positioned on a downstream end of the nozzle body; and (c) a nozzle cap defining a receiving opening configured to removably engage the coupling of the nozzle body, the nozzle cap forming a hood that extends in the downstream direction; wherein the nozzle cap extends from the nozzle body forming a continuous outer surface configured to shaping air flow passing over the nozzle cap and reducing airflow velocity in an atomization zone surrounding a spray jet of the fluid dispensing system; and wherein the nozzle cap forms a shielded dispersion area defining a reduced air velocity region when fluid is dispersed and undesired fine droplet formation is reduced.

In an example, the spray jet fluid is an agrochemical fluid configured for an aerial agrochemical application over a desired target area and the nozzle cap is sized and shaped to correspond least different spray tip sizes and airflow velocities of the aerial spray application, wherein the nozzle cap defines an outer rim diameter between 0.5 and 2.5 inches and a ratio of length to outer rim diameter between about 0.75 and 3.0 and corresponds to aerial application velocities from about 90 mph to about 160 mph. In another example, the aerodynamic hood can extend from a coupling configured to removably and securely connect the nozzle cap to the nozzle body and wherein the hood defines a concave interior geometry, and the spray tip protrudes within the concave body and the nozzle cap defines at least one orifice for dispersing fluid. The nozzle cap can be configured to reduce undesired fine droplet formation of droplets of about 100 μm during application to less than about 10%.

For purposes of summarizing the disclosure, certain aspects, advantages, and novel features of the disclosure have been described herein. It is to be understood that not necessarily all such advantages can be achieved in accordance with any one embodiment of the disclosure. Thus, the disclosure may be embodied or carried out in a manner that achieves or optimizes one advantage or group of advantages as taught herein without necessarily achieving other advantages as may be taught or suggested herein. The features of the disclosure which are believed to be novel are explicitly described and distinctly claimed in the concluding portion of the specification. These and other features, aspects, and advantages of the present disclosure will become better understood with reference to the following drawings and detailed description.

### BRIEF DESCRIPTION OF THE DRAWINGS

The figures which accompany the written portion of this specification illustrate example embodiments and methods of use for the present disclosure.

FIG. 1 illustrates an example aerial spraying apparatus according to the present disclosure.

FIG. 2A illustrates a partially exploded view of a portion of the aerial spraying apparatus of FIG. 1.

FIG. 2B illustrates an exploded view of the nozzle cap and spray tip of the aerial spraying apparatus of FIG. 2A.

FIG. 3A illustrates a rear view of an example nozzle cap and spray tip assembly of the present disclosure.

FIG. 3B illustrates a front view of the nozzle assembly of FIG. 3A with a spray tip installed.

FIG. 4A illustrates a side view of a “full shot” nozzle assembly of the present disclosure.

FIG. 4B illustrates a side view of a “half-shot” nozzle assembly of the present disclosure.

FIG. 5 illustrates a cross-section of a nozzle cap of the present disclosure with integrated spray tip.

FIG. 6 is a diagram illustrating flow patterns related to fluid flow turbulence intersecting a fluid dispersion.

FIG. 7A is an air flow diagram illustrating air flow around a standard straight-stream nozzle assembly.

FIG. 7B is an air flow diagram illustrating air flow around a nozzle assembly having a short-length nozzle cap “Dish” design as a base case.

FIG. 7C is an air flow diagram illustrating air flow around a relatively longer nozzle cap “Full-Shot” design.

FIG. 7D is an air flow diagram illustrating fluid flow around a relatively longer nozzle cap “Half-Shot” design.

FIG. 8A is a cross-section side view illustrating a “bullet” nozzle assembly of the present disclosure.

FIG. 8B illustrates an exploded view of the “bullet” nozzle assembly of FIG. 8A.

FIG. 9A illustrates a front perspective view of a nozzle cap and spray tip in a “bullet” nozzle assembly.

FIG. 9B illustrates a rear view of the “bullet” nozzle cap and spray tip of FIG. 9A.

FIG. 10 illustrates a multi-orifice spray tip for use in a system of the present disclosure.

FIG. 11A is a chart showing wind tunnel experimental data associated with an existing triple tip aerial nozzle.

FIG. 11B is a chart showing wind tunnel experimental data associated with a standard straight-stream nozzle assembly without a nozzle cap of the present disclosure.

FIG. 12A is a chart showing wind tunnel experimental data associated with a straight-stream dispersion spray tip using a nozzle cap “dish” design of the present disclosure.

FIG. 12B is a chart showing comparison data collected in FIG. 12A with the data provided in FIGS. 11A and 11B, showing percentage of increase and decreased particle size.

FIG. 13A is a chart showing wind tunnel experimental data associated with a nozzle cap “full shot” design (FIG. 4A) of the present disclosure for a straight-stream dispersion spray tip.

FIG. 13B is a chart showing comparison data collected in FIG. 13A with the data provided in FIGS. 11A and 11B, showing percentage of increase and decreased particle size.

FIG. 14A is a chart showing wind tunnel experimental data associated with a nozzle cap “half shot” design (FIG. 4B) of the present disclosure for a straight-stream dispersion spray tip.

FIG. 14B is a chart showing comparison data collected in FIG. 14A with the data provided in FIGS. 11A and 11B, showing percentage of increase and decreased particle size.

FIG. 15A is a chart showing wind tunnel experimental data associated with a “bullet” design (FIG. 8A-8B) of the present disclosure for a straight-stream dispersion spray tip.

FIG. 15B is a chart showing comparison data collected in FIG. 15A with the data provided in FIGS. 11A and 11B, showing percentage of increase and decreased particle size.

The various embodiments of the present disclosure will hereinafter be described in conjunction with the appended drawings, wherein like designations denote like elements.

### DETAILED DESCRIPTION

The following description is merely exemplary in nature and is not intended to limit the present disclosure, application, or uses. It should be understood that throughout the drawings, corresponding reference numerals indicate like or corresponding parts and features.

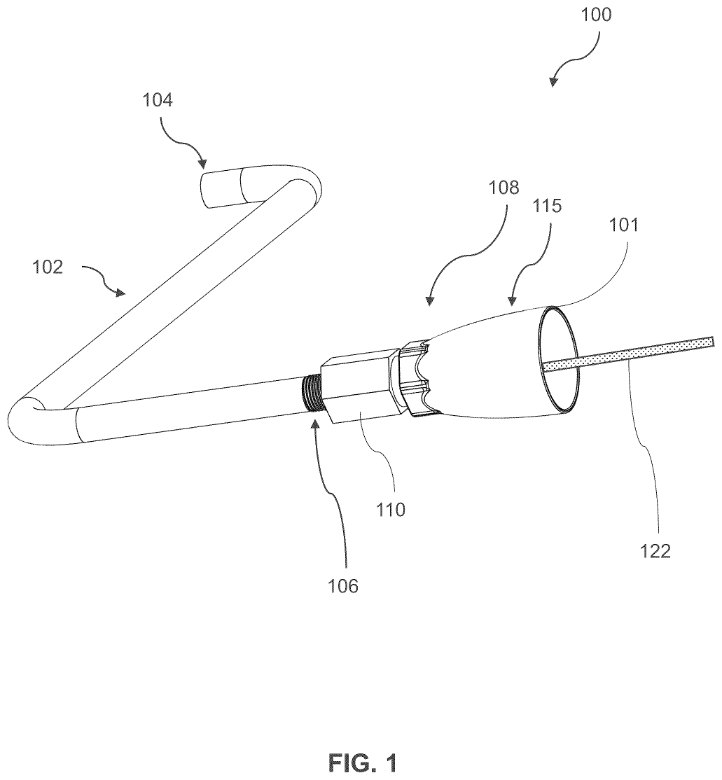

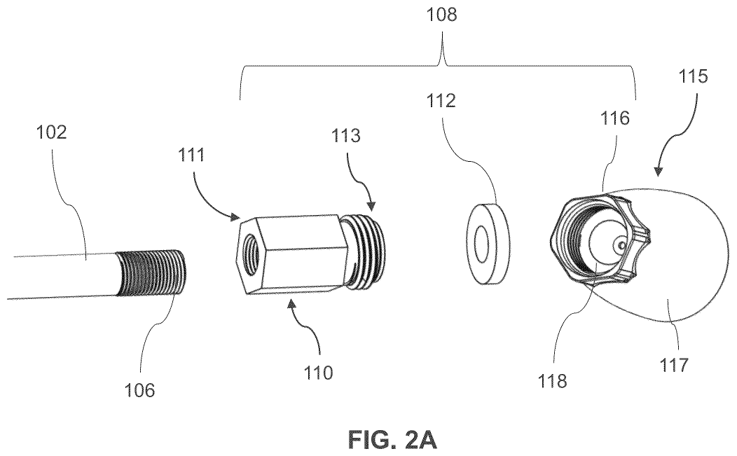

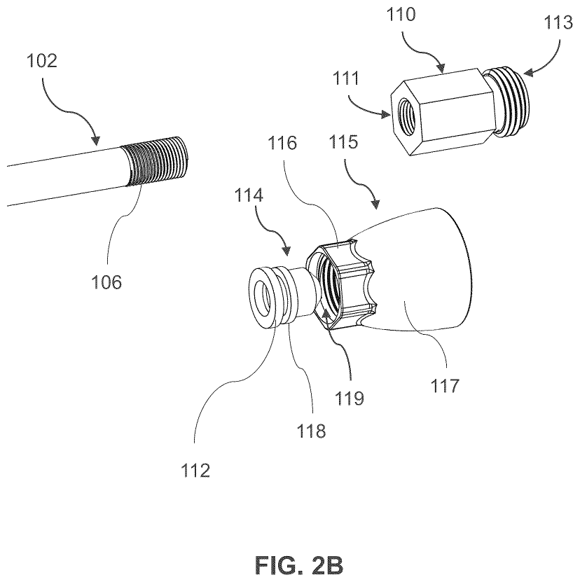

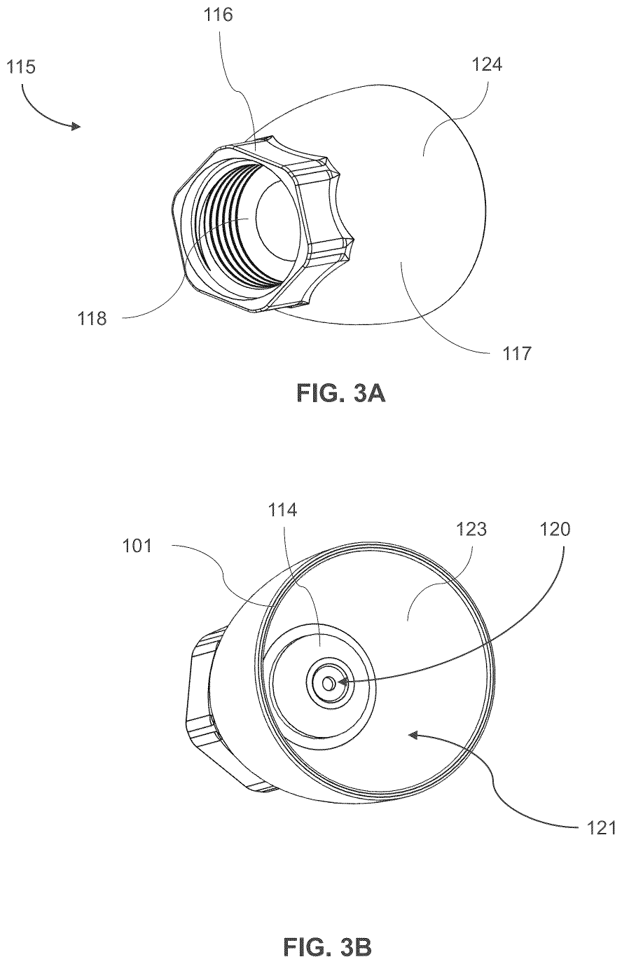

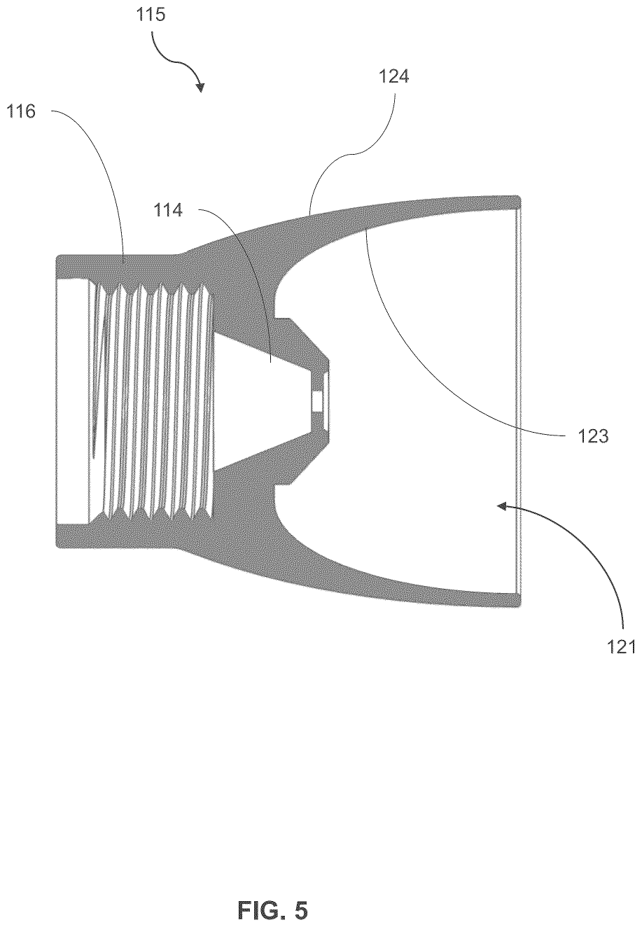

Referring to FIGS. 1-15B, the present disclosure provides for an aerial nozzle system for use with an aerial spraying apparatus 100. In an example, aerial spraying apparatus 100 is configured to be mounted below trailing edges of one or more wings of an aircraft and configured to deliver agrochemical fluid (typically in liquid form). In the example of FIGS. 1 and 2A-2B, the aerial spraying apparatus 100 includes a J-tube 102. J-tube 102 should be configured and oriented to position a dispersing system 108 having a nozzle cap 115 dropped below a boom of an aircraft. Agrochemical fluid is typically dispersed as an aircraft travels over a target area allowing the fluid to cover a desired crop/area of land. Aerial spraying apparatus 100 may be mounted on any aircraft including but not limited to a fixed wing aircraft, a helicopter, or an unmanned aircraft system (UAS). A proximal end 104 of J-tube 102 is configured to receive fluid from a fluid reservoir or delivery system (not shown) provided on an aircraft. In this example, distal end 106 of J-tube 102 is configured to connect to a fluid dispersing system 108. Distal end 106 may include a threaded portion for engaging a nozzle body 110 or any other connection means for ensuring a secure fit and fluid distribution therethrough. In another example, the dispersing system 108 includes spray nozzles that are connected or mounted directly to a spray boom.

In an example, dispersing system 108 includes a nozzle body 110, a sealing ring 112, and a nozzle cap 115. A proximal end 111 of nozzle body 110 is configured to securely connect to the distal end 106 of J-tube 102. In this example, nozzle body 110 includes internal threading to securely connect with mating threads provided on distal end 106 of J-tube 102. Nozzle body 110 may define a six-sided hex nut cross-section to allow for certain desired tooling for securing a connection. Distal end 113 of nozzle body 110 connects to a nozzle cap 115. In this example, the distal end 113 of nozzle body 110 may include external threads configured to securely connect to mating internal threads of a coupling 116 of nozzle cap 115 with a sealing ring 112 disposed therebetween. The sealing ring 112 may abut and form a seal against an annular flange 118 of a spray tip 114. Spray tip 114 may be a standalone component separated from nozzle cap 115 (as shown in the exploded view of FIG. 2B) or integrated with nozzle cap 115. In other examples, a bayonet or quarter-turn style connector may be deployed to mate the nozzle cap 115 to nozzle body 110 rather than the threads as presented. This may increase ease of use by making the spray tip replacement task tool-free. Considering that an operator may need to frequently swap spray tips between applications to adjust application rates or droplet sizes, this may improve efficiency and save time when in operation.

Nozzle cap 115 includes an aerodynamic hood (or outer shell) 117 extending from a coupling 116 surrounding an opening 119. Nozzle cap 115 is configured to receive a spray tip 114 through opening 119 and surrounded by hood 117. As nozzle body 110 is connected to coupling 116, a sealing ring 112 is positioned between distal end 113 and annular flange 118 of spray tip 114 forming a seal. Spray tip 114 may be a standalone component or integrated with nozzle cap 115. Sealing ring 112 may be EPDM or fluoropolymer, but can also be made of silicone, rubber, and/or other suitable plastic material or the like to provide a seal between nozzle body 110 and a spray tip 114. In an example, coupling 116 defines an external hexagonal nut shape configured to assist with increasing torque application during installation to provide for a better connection or seal. This can be done using tooling or other means. In another example, coupling 116 defines a different geometry like having two flat sides for gripping with a tool or otherwise.

During use, spray jet fluid 122 is expelled from spray tip 114 and immediately surrounded by aerodynamic hood 117. Aerodynamic hood 117 defines an outer shell and functions to block external air flow for a desired distance to prevent or shield spray jet fluid interaction with the surrounding air flow. In this example, aerodynamic hood 117 defines a partially conical or convex geometry and extends away from the spray tip 114 a sufficient distance to prevent undesired fluid droplet formation. Aerodynamic hood 117 is rounded and forms a convex, cone-like space that functions to shield fluid dispersed from the spray tip 114 within a shielded dispersion area 121. Nozzle cap 115 may be constructed from a corrosion resistant material including but not limited to metal, plastic, glass, or the like. The diameter of aerodynamic hood 117 gradually expands in the downstream direction forming the cone-like geometry.

In an example, nozzle cap 115 may be configured to be compatible with a standard dimension spray tip 114 for use in the aerial spraying industry. Nozzle cap 115 may be configured (i.e., sized and shaped) according to the type of agrochemical being applied and the fluid characteristics of that material or the characteristics of the spray tip(s). Agrochemicals may require a specific application rate, which depends on the travel speed and swath characteristics, which is dependent on the nozzle size, which would be impacted by the nozzle cap geometry. For example, depending on the viscosity or other properties of the applied agrochemical, a specific length of nozzle cap 115 can be selected and quickly and easily switched. In an example, aerodynamic hood 117 defines an inner surface 123 and an outer surface 124 extending away from the coupling 116 in an axial direction. Nozzle cap 115 defines an outer rim 101 surrounding a shielded dispersion area 121. Outer rim 101 defines a diameter sufficient for preventing undesired air flow disruption to fluid dispersing from the spray tip 114. In an example, outer rim 101 defines a diameter of 1.25 inches.

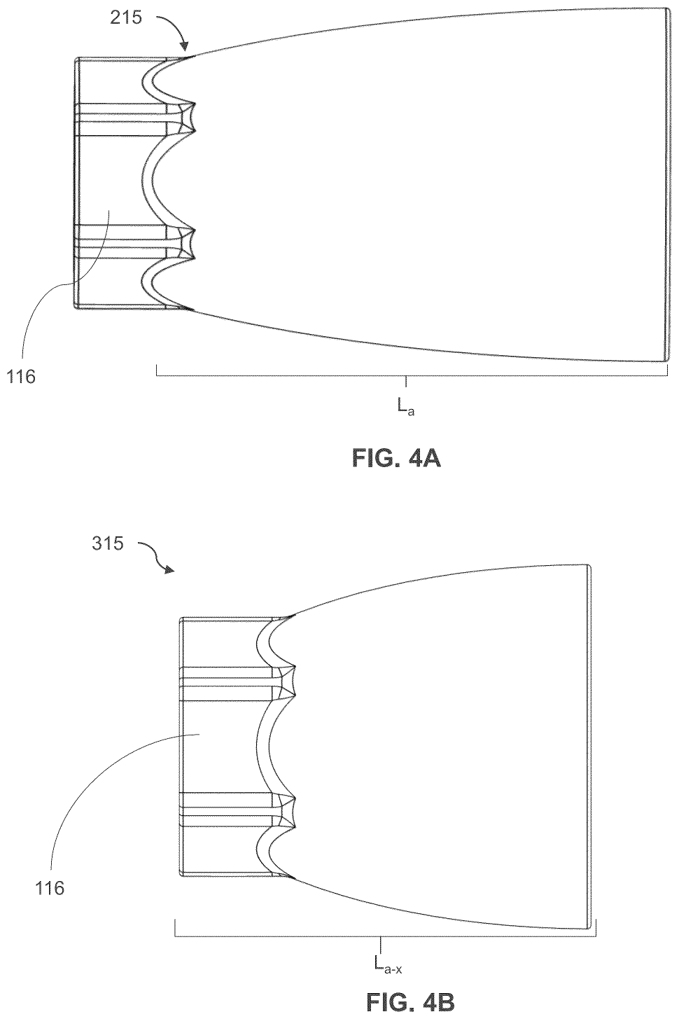

FIG. 4A illustrates a “Full Shot” nozzle cap 215 defining an axial length (La) that is relatively longer than that of a “Half shot” nozzle cap 315 defining an axial length of La-x shown in FIG. 4B. In an example, the length of the nozzle cap can range from 1 to 2 inches. The designed length of a nozzle cap can vary depending on the dispersion characteristics of a desired fluid and can be relatively longer or shorter. Environmental conditions can also be considered when selecting a desired nozzle cap. A benefit of the “full shot” design allows for increased length of the shielded dispersion area 121 in addition to guiding the air around the spray tip 114. Guiding air flow around the nozzle cap 115 reduces turbulence downstream in both intensity and length.

During operation, nozzle cap 115 provides a windbreak to spray jet fluid 122 as it is discharged out of orifice 120. In an example, an aircraft may be traveling at speeds between 120 mph to 180 mph in relation to the ground. The agrochemical is dispersed from dispersing system 108 in an opposite direction of travel of the aerial vehicle. Air flow passing over and around the aircraft is thus moving in substantially the same direction as spray jet fluid 122.

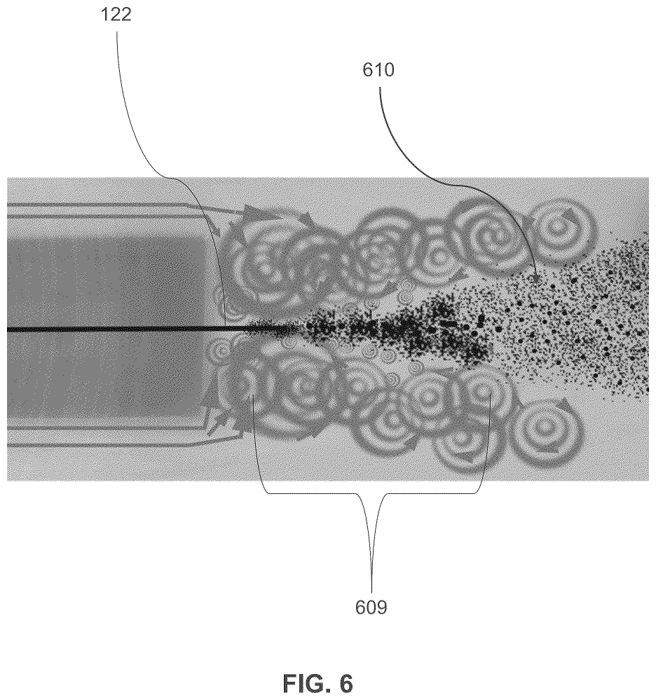

As air flows around sharp edges adjacent to flat surfaces around the spray orifice 120, an increase in turbulent eddies and vortex shedding may be observed. This can be seen by the diagram of FIG. 6 where the effect on spray jet fluid 122 is shown. The unoptimized nozzle surface geometry results in turbulent air imparting shear forces on the spray jet fluid 122. The interaction results in oscillations and fibrous spray detachment if the flow of the spray jet fluid has not been developed. This can result in an atomization zone 609 surrounding the spray jet fluid 122 that atomizes the fluid to fine droplets 610 that are more susceptible to undesired drift. Fine droplets 610 waste resources and present a danger of misapplication to non-target properties.

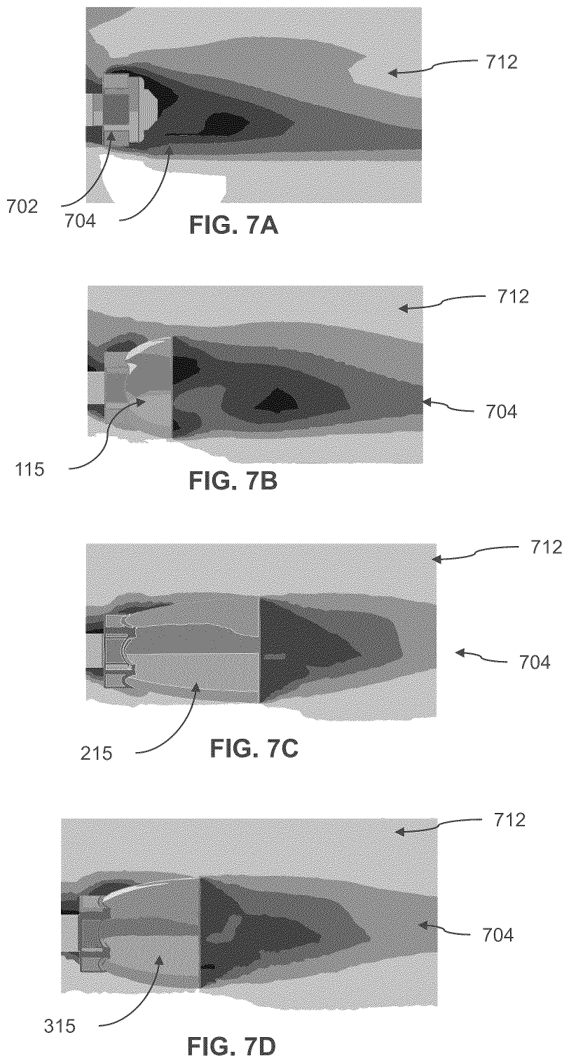

In an example, nozzle cap 115 can assist in preventing the formation of fine droplets 610 by blocking or shielding the travel of external air flow near the spray orifice 120. Referring to FIG. 7A, an air flow velocity profile is shown passing over a standard nozzle assembly 702. This does not include a nozzle cap of the present disclosure. The diagram models flow patterns using computational fluid dynamic modeling, wherein the darker area represents lower velocity air 704 as compared to the lighter areas which represent higher velocity air 712. A small region of lower velocity air 704 is formed immediately behind standard nozzle cap 702 and is quickly replaced by regions of lighter color that represent increased velocities. The nozzle cap 115 increases the length of the lower velocity region. This helps reduce the likelihood of undesired droplet formation.

FIG. 7B illustrates air flow under the same modeled conditions as FIG. 7A are shown. In this example, a base-case “Dish” design of a nozzle cap 115 is provided to confirm a shielding effect on a fluid stream. Nozzle cap 115 is configured to reduce the impacts of higher velocity air by shielding/blocking the travel of external air flow. Shielded dispersion area 121 contains a significantly larger region of lower velocity air 904, therefore less interference or disruption is experienced by spray jet fluid 122 as it is dispersed out from the dispersion system.

FIGS. 7C and 7D are yet further examples of air flow diagrams under the same conditions as FIGS. 7A-7B. In these examples, nozzle cap 215 (“full shot”) and nozzle cap 315 (“half shot”) are shown. The lower velocity air depicted by the darker area 704 extends downstream out and away from nozzle cap 215/315. The lower velocity air shown by darker area 704 can minimize undesired interactions with the higher velocity air flow.

In use, as spray jet fluid 122 disperses from orifice 120 its path can extend through the zone of lower velocity air 704 and downstream eventually intersecting the higher velocity air 1102 represented by the lighter area. Due to the flow path of spray jet fluid 122 through the zone of low velocity air 704, spray jet fluid 122 intersects the air flow with minimal turbulent eddies and vortex shedding.

As air flow travels over the nozzle cap, it will naturally shift directions to fill in the region behind nozzle cap at a lower velocity than the surrounding air. The shape of the nozzle cap shields spray jet fluid 112 from high velocity air that would result in fine droplets and stops the formation of turbulent eddies or vortex shedding by guiding the air flow around the nozzle cap. This allows the spray jet fluid 122 to fully develop before being exposed to the higher velocity air 712, which results in less fluid disruption to the dispersion spray jet fluid 122.

The elongated shape of the nozzle cap provides spray jet fluid 122 with a moment to establish a stable flow pattern or a desired flow pattern with reduced atomization. The spray jet fluid 122 establishes a stable flow pattern within the zone of lower velocity air 704 as spray jet fluid 122 is discharged out from spray tip 114. A stable flow pattern for spray jet fluid 122 increases its ability to withstand any shearing forces experienced by turbulence or higher velocity air. Further, an elongated nozzle cap allows the spray jet fluid 122 to begin to form larger droplets that are more suitable for aerial application.

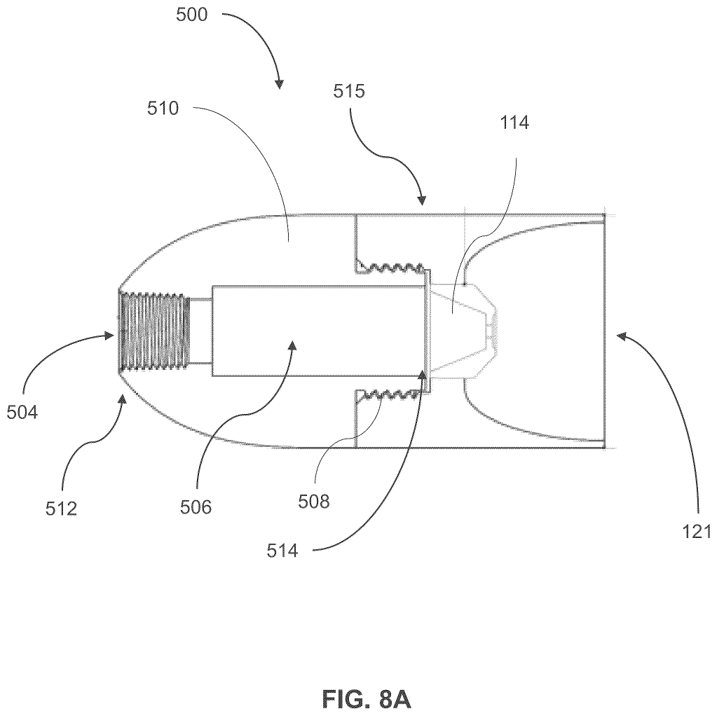

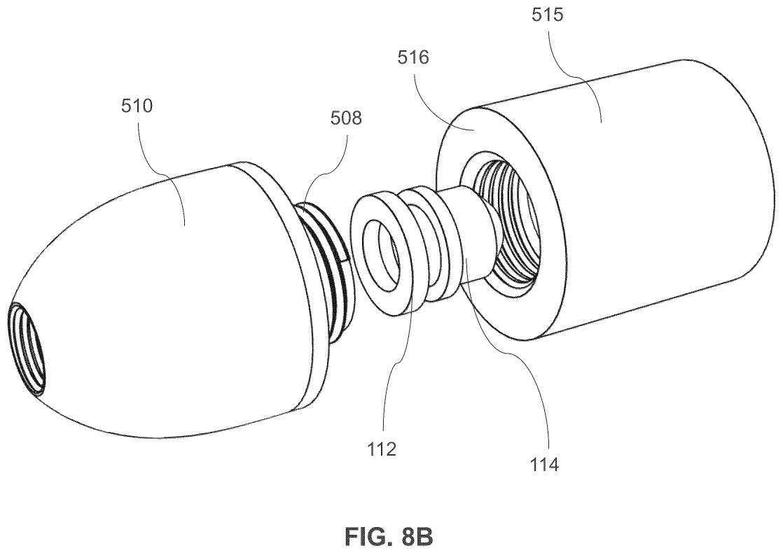

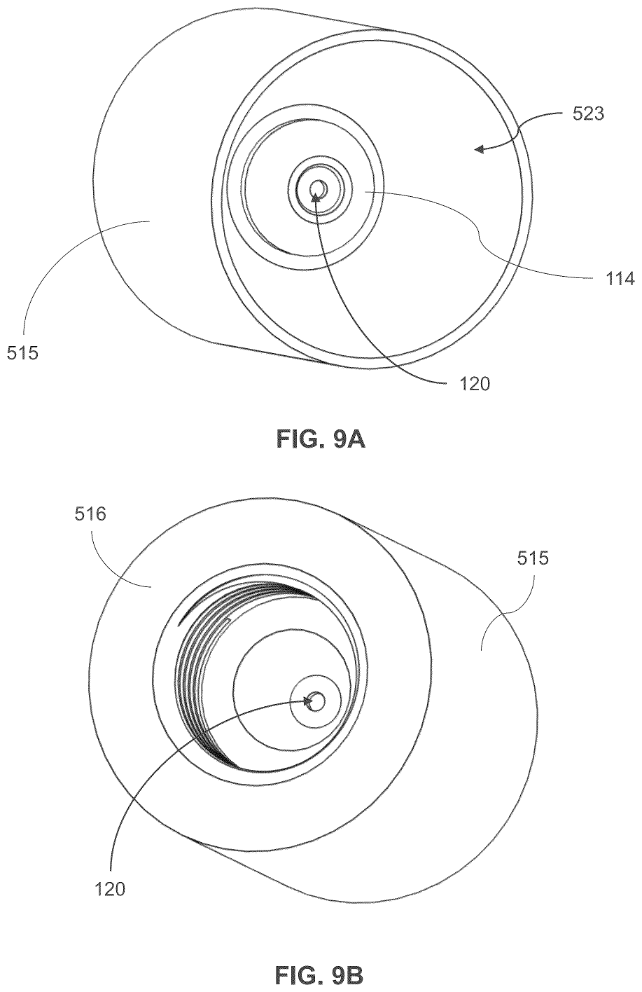

Referring to FIGS. 8A-8B and 9A-9B, in another example, “Bullet” nozzle assembly 500 is provided and includes a larger diameter bullet body 510 configured for securely connecting to a dispersion source. In this example, bullet body 510 defines a “bullet” shape having a connector end 512 defining a curved or “dome-like” geometry that gradually expands downstream to a uniform diameter. This may include a substantially cylindrical shape, a continuous taper, and/or an arc configuration. Bullet body 510 defines an internal passage 506 extending axially from port 504 through bullet body 510 to its opposite downstream end 514. Internal passage 506 forms an open channel such that bullet body 510 is in fluid communication with the orifice 120 of spray tip 114. Bullet cap 515 can define a continuous cylindrical geometry.

In an example, bullet body 510 includes a bullet coupling 508 for engaging with a bullet cap 515. Bullet cap 515 is a nozzle cap that includes a connection for engaging the bullet body 510. In this example, the bullet coupling 508 is threaded and bullet cap 515 includes mating threads to form the connection. Bullet body 510 and bullet cap 515 may define substantially matching diameters such that when assembled, a flush connection results in the axial direction between the annular external surfaces of bullet body 510 and bullet cap 515.

In an example, bullet cap 515 defines a substantially uniform outer diameter and further includes a proximal external face 516. Bullet cap 515 functions to shield spray like nozzle hood 117 but defining a different geometry. Hood 117 could have a hooded outer geometry or a uniform outer diameter. External face 516 of nozzle cap 515 may define unique and functional shapes to make it easier to remove.

Bullet cap 515 extends out in a downstream direction beyond spray tip 114 from proximal external face 516. An annular inner surface 523 of bullet cap 515 defines a curved surface such that the diameter of the inner surface gradually expands in a downstream direction. The inner surface 523 of bullet cap 515 surrounds a shielded dispersion area 121.

In an example, spray jet fluid 122 is dispersed through internal passage 506 into spray tip 114. The spray jet fluid 122 is then subsequently dispersed through orifice 120. Upon discharge from orifice 120 spray jet fluid 122 enters and passes through the dispersion area 121 in a downstream direction and into a zone of lower velocity air.

A zone of lower velocity air is formed by air flow passing over the shape and geometry of nozzle assembly 500. The air flow moves around and over both components. Air flow is shielded from orifice 120 such that fluid 122 disperses into a zone of lower velocity air. The length of the bullet cap 515 extends the length of the shielded dispersion area and can prevent, improve, and/or reduce undesired droplet formation.

In another example, air bypass channel(s) are formed in the nozzle cap, and are configured to reduce entrainment of droplets within the cap. Due to the high-speed air flowing over the cap, an area of low-pressure air is observed in the cap. This acts like suction. When the spraying stops, some droplets can remain entrained in the cap for an extended period of time leading to off-target deposition. The nozzle cap may include one or more air passages from the exterior to the interior of the nozzle hood to reduce or ensure droplets do not remain entrained within the hood after spray application has ceased.

Multiple factors influence spraying system behavior. These include but are not limited to spray tip size or orifice diameter, spray fluid pressure, flow rate, viscosity of the sprayed fluid, nozzle assembly geometry, wear of the spray tip orifice 120, application speed or surrounding air flow velocity, and angle of attack by the aircraft or the nozzle angular position. The corresponding spectrum of droplet sizes and droplet quantities are influenced by these factors. Droplet diameter is associated with the risk of off-target deposition. The motion of smaller droplets, typically those with a nominal diameter of less than 100 microns (μm), are greatly influenced by environmental factors including temperature, humidity, and wind, whereas larger droplets, typically characterized as those over 200 μm, are heavily influenced by gravity. Smaller, driftable droplets are likely to be generated at some level, regardless of the spraying equipment configuration, and minimizing these droplets provides the best opportunity to minimize risks from drift.

The present disclosure provides for a nozzle cap that can assist with minimizing driftable droplets (as defined by the droplet diameters less than 100 μm) by optimizing the external geometry. One approach is to reduce air velocity at and around the dispersion of the fluid to stabilize dispersion. Using a nozzle cap of present disclosure, a reduction of droplets of less than 100 μm in diameter to 10% or less of the droplet spectrum can be achieved from a standard dispersion event.

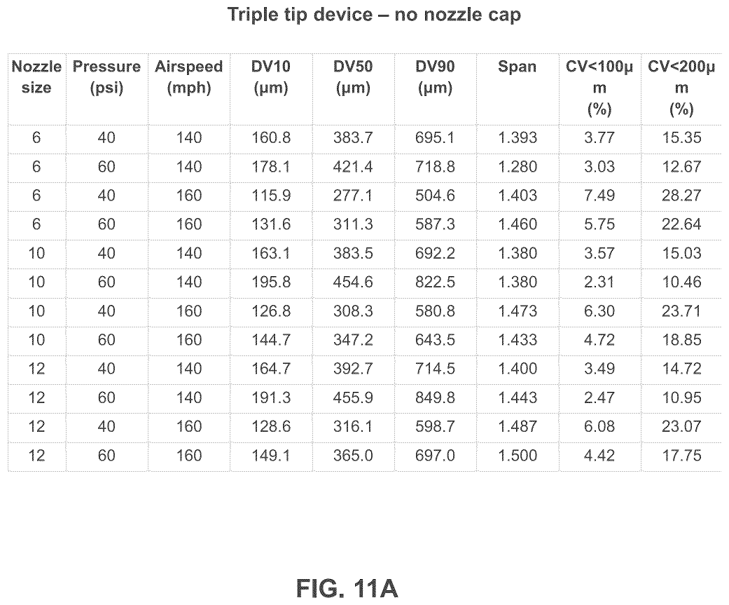

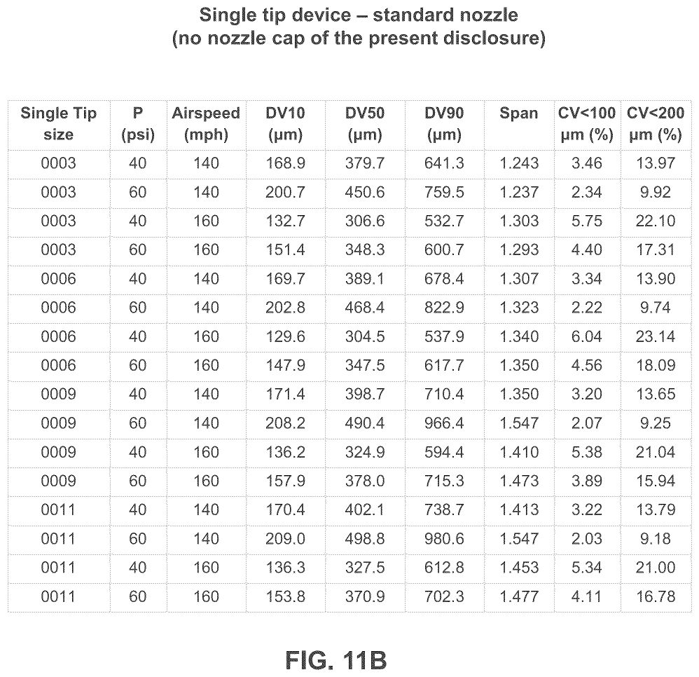

Referring to the charts of FIGS. 11A-11B, 12A-12B, 13A-13B, 14A-14B, and 15A-15B, experiments were conducted in a wind tunnel to determine the effects of nozzle caps of the present disclosure on undesired droplet formation. A concave “Dish” design (like the Dish nozzle cap of FIG. 7B) was first tested as a base-case as compared to the data collected from a spray test with a nozzle assembly of FIG. 7A. Industry standard nozzles can include a quick-selectable aerial triple tip nozzle with three straight-stream spray tips installed and interchangeable by rotating a nozzle tip turret. This can also include a single spray nozzle with a straight-stream spray tip installed. The tests were run using spray tips rated for dispersion of fluid on a gallon per minute (gpm) basis and pressure rating of pounds per square inch (psi). A triple tip nozzle assembly may include three rotatable spray tips to allow for adjusting flow rates. The triple tip nozzle assembly may include 0.8 gpm, 1.0 gpm, and 1.2 gpm spray tips. A standard single spray nozzle assembly (without an aerodynamic cap of the present disclosure) was also tested at varying dispersion rates. The standard single spray tips were selected as 0.3 gpm, 0.6 gpm, 0.9 gpm, and 1.1 gpm.

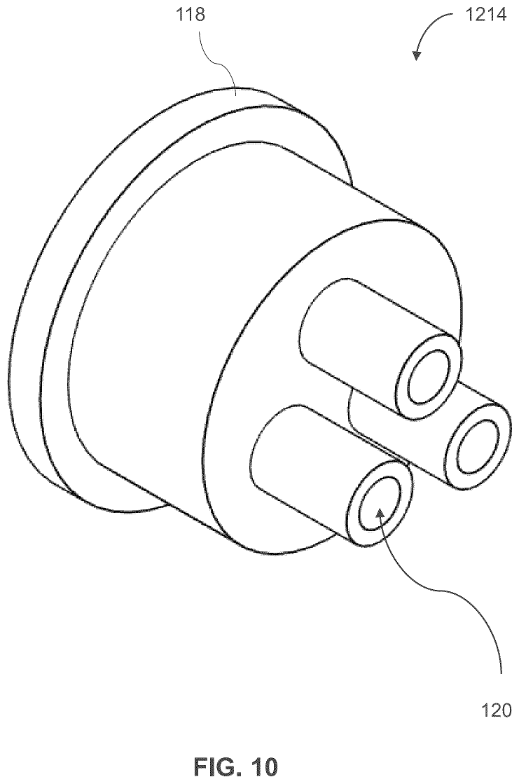

In the example of FIG. 10, multi-orifice spray tip 1214 may include one or more orifices 120, which can be interchangeable with a standard spray tip 114 or integrated into a nozzle cap of the present disclosure. In one example, spray tip 1214 has three orifices 120. The multi-orifice configuration allows for increased flow rate as all orifices are used simultaneously. Each stream of spray fluid 122 is largely if not entirely protected from the high velocity air by the aerodynamic hood of a nozzle cap. Other examples may include even more orifices, depending on the suitability for a desired application process or system.

Wind tunnel tests were performed using the high-speed wind tunnel at the USDA-ARS Aerial Application Technology Research Unit in Bryan, Texas. This facility is used for testing, evaluating and rating aerial nozzles. The nozzles were tested at two airspeeds (140 mph and 160 mph), and two fluid pressures (40 psi and 60 psi). Nozzles were attached to a typical boom section including a J-tube to simulate actual conditions in field use. This is the standard evaluation method.

Nozzles were analyzed with a Sympatec Helos KF laser diffraction droplet measurement system (Sympatec GmbH). Multiple samples (typically 3 or more) were taken for each combination of nozzle, pressure, and wind speed. Values found in the results section reflect the average of these samples. When interpreting the results, the DV10, DV50, and DV90 reflect the droplet diameters of the 10th, 50th, and 90th percentiles of total spray volume. This provides a base understanding of the range of droplet diameters produced. The CV<100 reflects the total cumulative volume of droplets under 100 μm. A spray that produces fewer driftable droplets will have a lower CV<100 value. A decreased CV<200 (which reflects the total cumulative volume of droplets under 200 μm) can also be an indicator of fewer driftable fines. Control subject nozzles (i.e., the data from a triple tip nozzle (FIG. 11A) and a standard straight-stream (FIG. 11B)) underwent wind tunnel testing, however, the standard straight-stream nozzle assembly produced a spray with significantly fewer driftable fines than the triple tip nozzle assembly. The data from FIGS. 11A and 11B provided comparison data to the subsequent nozzle caps.

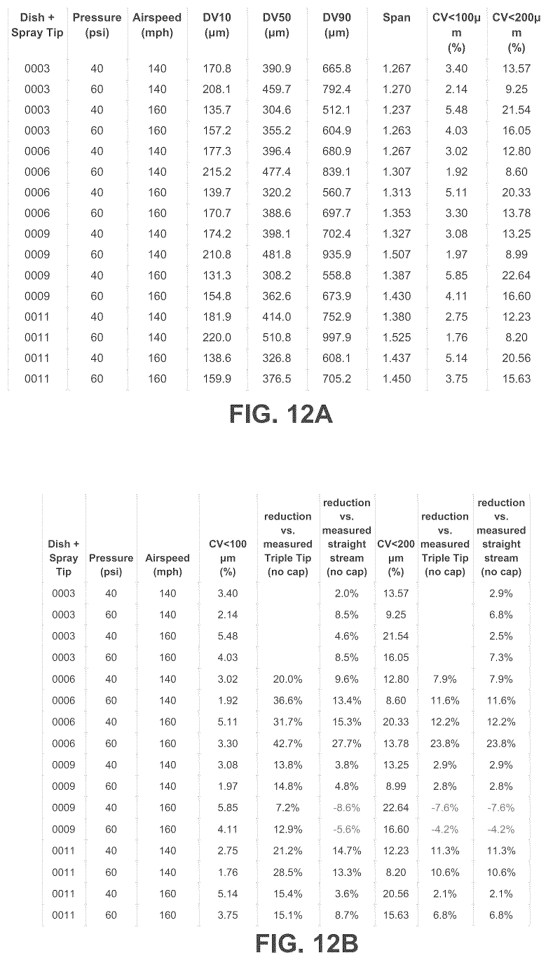

The “Dish” design of FIG. 7B results in an “air dam” that reduces air energy adjacent to the nozzle cap, allowing a moment for the dispersion fluid to form a ligament in a stabilized flow pattern. The formation of the nozzle cap includes a semi-protrusion of the spray tip 114 surrounded by a concave dish shape. This forms a circular void that shields the dispersion fluid. Test data of the “Dish” design (FIGS. 12A-12B) produced droplets with a CV<100 of less than 6% and CV<200 μm to less than 23%. The CV<100 was reduced by up to 28% and the CV<200 was reduced by up to 24% compared to the standard straight-stream nozzle assembly.

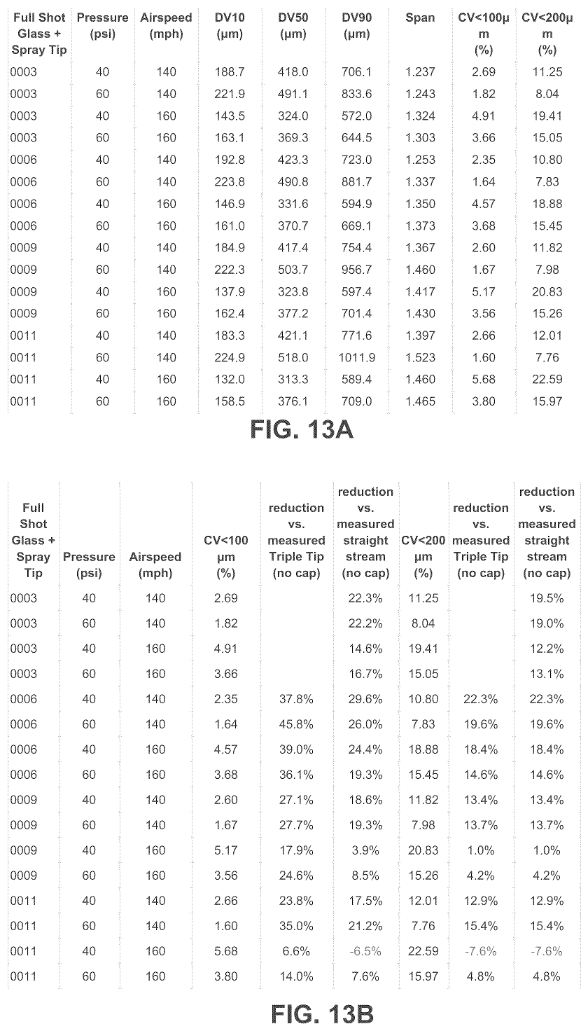

FIGS. 13A-13B illustrate wind tunnel experiments associated with the “Full Shot” nozzle cap of FIG. 4A. The test data produced a CV<100 of less than 6% and CV<200 of less than 23%. In a further example, the CV<100 was reduced by up to 30%, and the CV<200 was reduced by up to 23%, compared to the triple tip or standard straight-stream.

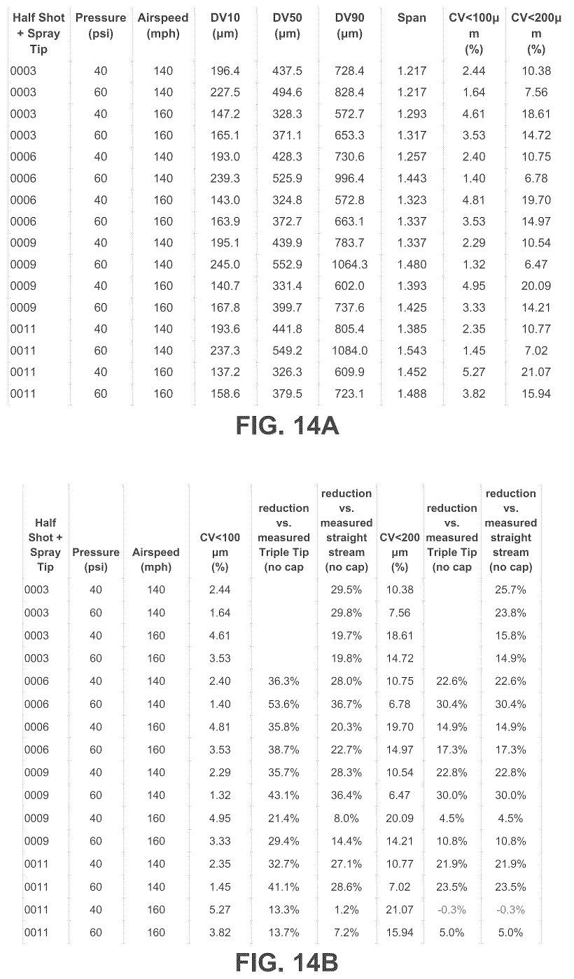

FIGS. 14A-14B illustrate wind tunnel experiments associated with the “Half Shot” nozzle cap of FIG. 4B. The test data produced a CV<100 of less than 6% and CV<200 of less than 22%. In a further example, the CV<100 was reduced by up to 37%, and the CV<200 was reduced by up to 31%, compared to the triple tip or standard straight-stream.

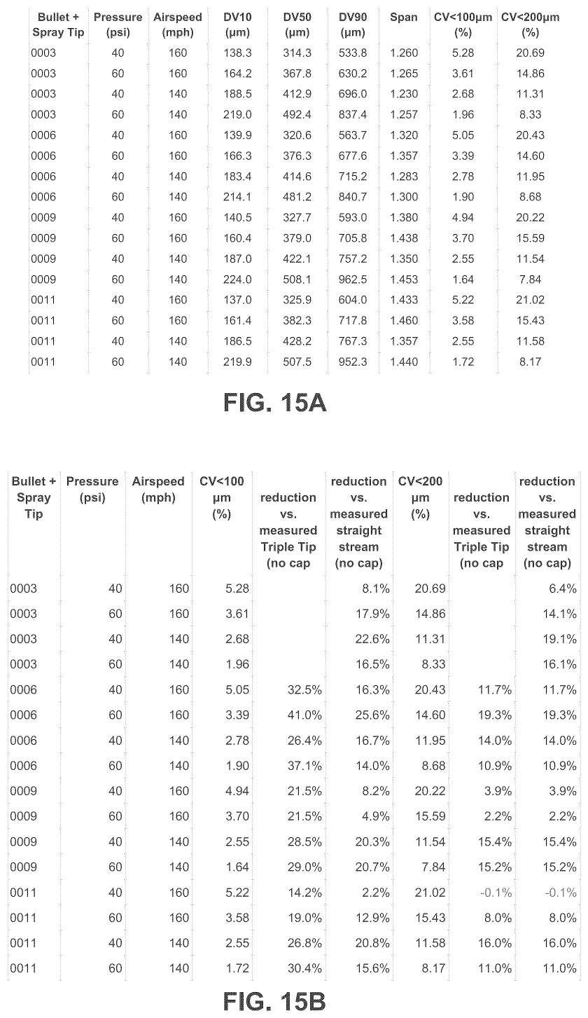

FIGS. 15A-15B illustrate wind tunnel experiments associated with the “Bullet” configuration of FIGS. 8A-8B. The test data produced a CV<100 of less than 6% and CV<200 of less than 22%. In a further example, the CV<100 was reduced by up to 26%, and the CV<200 was reduced by up to 20%, compared to the triple tip or standard straight-stream.

The foregoing description of various forms of the invention has been presented for purposes of illustration and description. It is not intended to be exhaustive or to limit the invention to the precise forms disclosed. Numerous modifications or variations are possible in light of the above teachings. The forms discussed were chosen and described to provide the best illustration of the principles of the invention and its practical application to thereby enable one of ordinary skill in the art to utilize the invention in various forms and with various modifications as are suited to the particular use contemplated. All such modifications and variations are within the scope of the invention as determined by the appended claims when interpreted in accordance with the breadth to which they are fairly, legally, and equitably entitled.

What is claimed is:

1. An aerial nozzle cap, configured to connect a spray tip to a nozzle body of an aerial spray applicator fluid distribution system, the aerial nozzle cap comprising: an aerodynamic hood extending downstream and away from the spray tip, the aerodynamic hood configured to shield the spray tip and spray jet fluid emitted from the fluid distribution system from airflow passing over the nozzle cap during a spray application; wherein the hood is configured to shape the airflow conditions around the spray tip and nozzle cap to form a zone of lower velocity and lower energy air during the spray application to prevent undesired droplet formation.

2. The aerial nozzle cap of claim 1, wherein the nozzle cap includes a coupling extending from a base of the aerodynamic hood configured to connect to the nozzle body and allow fluid to be dispersed within the zone of lower velocity air and lower energy air.

3. The aerial nozzle cap of claim 1, wherein the spray jet fluid is an agrochemical fluid configured for an aerial agrochemical application over a desired target area.

4. The aerial nozzle cap of claim 1, wherein the nozzle cap is sized and shaped to correspond to different spray tip orifice sizes and airflow velocities of the aerial spray application.

5. The aerial nozzle cap of claim 4, wherein the nozzle cap defines an outer rim diameter between 0.5 and 2.5 inches.

6. The aerial nozzle cap of claim 5, wherein the nozzle cap defines an outer rim diameter between 1.0 and 2.0 inches.

7. The aerial nozzle cap of claim 5, wherein the nozzle cap defines a ratio of length to outer rim diameter between about 0.75 and 3.0.

8. The aerial nozzle cap of claim 7, wherein the ratio of length to outer rim diameter corresponds to aerial application velocities from about 90 mph to about 160 mph.

9. The aerial nozzle cap of claim 1, wherein the aerodynamic hood extends from the coupling configured to removably and securely connect the nozzle cap to the nozzle body.

10. The aerial nozzle cap of claim 1, wherein the hood defines a concave interior geometry and the spray tip protrudes within the concave body.

11. The aerial nozzle cap of claim 1, wherein the spray tip is formed integral with the nozzle cap and the nozzle body.

12. The aerial nozzle cap of claim 11, wherein the spray tip defines at least one orifice for dispersing fluid.

13. The aerial nozzle cap of claim 12, wherein the spray tip defines a plurality of orifices for dispersing fluid.

14. The aerial nozzle cap of claim 1, wherein the nozzle cap is configured to reduce the volume of undesired fine droplet formation consisting of droplet diameters of about 100 μm and smaller during application to less than about 10%.

15. The aerial nozzle cap of claim 1, wherein the nozzle cap includes one or more air passages from an exterior to an interior of the nozzle hood configured to prevent droplets from remaining entrained within the hood after a spray application has ceased.

16. An aerial nozzle assembly comprising:
(a) a nozzle body extending in a downstream direction defining an opening at an upstream end for securely connecting to a fluid dispensing system and having at least one internal fluid channel extending to a downstream end;
(b) a coupling positioned on a downstream end of the nozzle body;
(c) a nozzle cap defining a receiving opening configured to removably engage the coupling of the nozzle body, the nozzle cap forming an aerodynamic hood that extends in the downstream direction, with at least one internal fluid channel extending to a downstream end; and
(d) an orifice positioned on the downstream end of the nozzle body and within the aerodynamic hood that is sized to dispense a spray jet of the fluid dispensing system or allows for the installation of a spraying tip;
wherein the nozzle cap extends from the nozzle body forming a continuous outer surface configured to shaping air flow passing over the nozzle cap and reducing airflow velocity in an atomization zone surrounding a spray jet of the fluid dispensing system; and
wherein the nozzle cap forms a shielded dispersion area defining a reduced air velocity region when fluid is dispersed and undesired fine droplet formation is reduced.

17. The aerial nozzle cap of claim 16, wherein the spray jet fluid is an agrochemical fluid configured for an aerial agrochemical application over a desired target area and the nozzle cap is sized and shaped to correspond to different spray tip orifice sizes and airflow velocities of the aerial spray application, wherein the nozzle cap defines an outer rim diameter between 0.5 and 2.5 inches and a ratio of length to outer rim diameter between about 0.75 and 3.0 and corresponds to aerial application velocities from about 90 mph to about 160 mph.

18. The aerial nozzle cap of claim 16, wherein the aerodynamic hood extends from a coupling configured to removably and securely connect the nozzle cap to the nozzle body and wherein the hood defines a concave interior geometry and the spray tip protrudes within the concave body and the nozzle cap defines at least one orifice for dispersing fluid.

19. The aerial nozzle cap of claim 16, wherein the nozzle cap is configured to reduce the volume of undesired fine droplet formation consisting of droplet diameters of about 100 μm and smaller during application to less than about 10%.

20. The aerial nozzle cap of claim 16, wherein the nozzle cap includes one or more air passages from an exterior to an interior of the nozzle hood configured to prevent droplets from remaining entrained within the hood after a spray application has ceased.
